(19) United States
(12) Patent Application Publication
(10) Pub. No.: US 2008/0152448 A1
(43) Pub. Date: Jun. 26, 2008

(54) ROUTER

(76) Inventors: Adolf Zaiser, Koengen (DE); Heiko Roehm, Stuttgart (DE); Jens Blum, Filderstadt (DE)

Correspondence Address: Striker, Striker & Stenby, 103 East Neck Road, Huntington, NY, 11743, US

(21) Appl. No.: 11/930,857

(22) Filed: Oct. 31, 2007

(30) Foreign Application Priority Data
Dec. 22, 2006 (DE) 102006061236.1

(51) Int. Cl. B23C 1/20

(52) U.S. Cl. 409/182; 409/137

(57) ABSTRACT

A router operatable by an operator has a motor housing including at least one handle, a drive motor, a milling tool connected with the drive motor, a tool fitting provided for the milling tool and extending from an underside of the housing, a cooling device including an intake device for drawing cooling air in through intake openings in the motor housing, a cooling air guide for directing cooling air through the motor housing and, and an exhaust device for exhausting cooling air out of the motor housing, arranged so that the cooling air guide leads into the exhaust device and configured such that when the router is used as intended, the cooling air is only exhausted in at least one region of the router pointing away from the operator.

### CROSS-REFERENCE TO A RELATED APPLICATION

The invention described and claimed hereinbelow is also described in German Patent Application DE 1020061236.1 filed on Dec. 22, 2006. This German Patent Application, whose subject matter is incorporated here by reference, provides the basis for a claim of priority of invention under 35 U.S.C. 119(a)-(d).

### BACKGROUND OF THE INVENTION

The present invention generally relates to routers.

A generic router that can be operated by an operator is made known in DE 41 39 759 A1. The router includes a motor housing with two handles, and a drive motor located in the motor housing. A tool fitting connected with the drive motor extends out of the underside of the motor housing. The router includes a cooling device for cooling the drive motor, with an intake device, a cooling air guide, and an exhaust device for exhausting the cooling air axially.

### SUMMARY OF THE INVENTION

Accordingly, it is an object of the present invention to provide a router which is a further improvement of the existing routers.

The router in accordance with the present invention may be operated by an operator, it has a motor housing that includes at least one handle and from the underside of which a tool fitting for a milling tool connected with the drive motor extends, and a cooling device, which includes an intake device for drawing cooling air in through intake openings in the motor housing, and a cooling air guide for directing cooling air through the motor housing, cooling air guide leading into an exhaust device with means for exhausting cooling air out of the motor housing.

It is provided in the router in accordance with the present invention that the means of the exhaust device are designed such that, when the router is used as intended, the cooling air is only exhausted in at least one region of the router pointing away from the operator. A design of this type makes it possible to operate the router without disruption, since the warmed cooling air exits in a region of the router pointing away from the operator. An exhausting of the cooling air of this type ensures that the chips produced during milling are blown away from the operator via the cooling air.

In a further embodiment, it is provided that an at least one means of the exhaust device is a cooling air channel, which leads to a side of the router facing away from the operator. This results in a cooling air guide that may be directed around the drive motor. This cooling air guide leads into the cooling air channel, which directs the cooling air to the side of the operator facing away from the operator. This embodiment ensures that the cooling air, and the chips, are not blown toward the operator.

It is also provided that an at least one means of the exhaust device is a cooling air channel, which leads out of the motor housing and into the handle. This also results in a cooling air guide that may be directed around the drive motor.

In a further embodiment, it is provided that the cooling air guide at least partially leads into the cooling channel. It is provided, in particular, that the part of the cooling air guide extending on a side of the router facing the operator leads into the cooling channel. As a result, the portion of cooling air that is most disturbing to the operator is directed away from the operator. This allows the operator to work with even less disruption.

It is also provided that the part of the cooling air guide extending on a side of the router facing away from the operator leads into several, axially downwardly extending cooling channels. As a result, the portion of cooling air that is unproblematic for the operator is directed out of the motor housing in the conventional manner. The conventional exhaust device can therefore be retained as-is, which reduces costs.

In a further embodiment, it is provided that the cooling air channel is spiral in design. This design of the cooling air channel allows the cooling air channel to be adapted in an optimal manner to the motor housing of the router, and it allows the cooling air to flow out of the motor housing in an optimal manner.

It is also provided that cooling air channel leads into at least one exhaust opening. Positioning the at least one exhaust opening in a specific manner makes it possible to prevent the exhausted cooling air from being blown onto the operator.

In a further embodiment, it is provided that the at least one exhaust opening is designed as a slot, which allows the warmed cooling air to be exhausted evenly.

In a further embodiment, it is provided that the at least one exhaust opening is located on an underside of the handle. It is also provided that the at least one exhaust opening is located in a region of the underside of the motor housing pointing away from an operator. Both embodiments permit cooling air to be exhausted axially, i.e., they allow the cooling air to be exhausted essentially in the direction of a vertical axis. In this context, “essentially” is understood to mean that slight deviations from the safety margin are included. The deviations are preferably less than 15% and, particularly advantageously, less than 10%. The axial exhausting of the cooling air is advantageously directed downward, so that chips are simultaneously carried away in an optimal manner.

It is also provided that several exhaust openings are located on the underside of the motor housing in the shape of a half moon, which allows the warmed cooling air to be exhausted evenly.

Further advantages result from the description of the drawing, below. A conventional router is depicted in a first drawing, and an exemplary embodiment of the present invention is depicted in the other two drawings. The drawing, the description and the claims contain numerous features in combination. One skilled in the art will also advantageously consider the features individually and combine them to form further reasonable combinations.

### BRIEF DESCRIPTION OF THE DRAWINGS

FIG. 1 shows a partial sectional view of a conventional router with a cooling device, which includes an intake device, a cooling air guide, and an exhaust device for exhausting the cooling air axially, and

FIG. 2 shows a schematically depicted, inventive router in a view of the motor housing from below, in the case of which the exhaust device is designed such that the cooling air is exhausted in regions directed away from an operator, and

FIG. 3 shows a simplified depiction of the inventive router with a top view of the side facing away from an operator. The axial exhausting of the cooling air is indicated by arrows.

### DESCRIPTION OF THE PREFERRED EMBODIMENTS

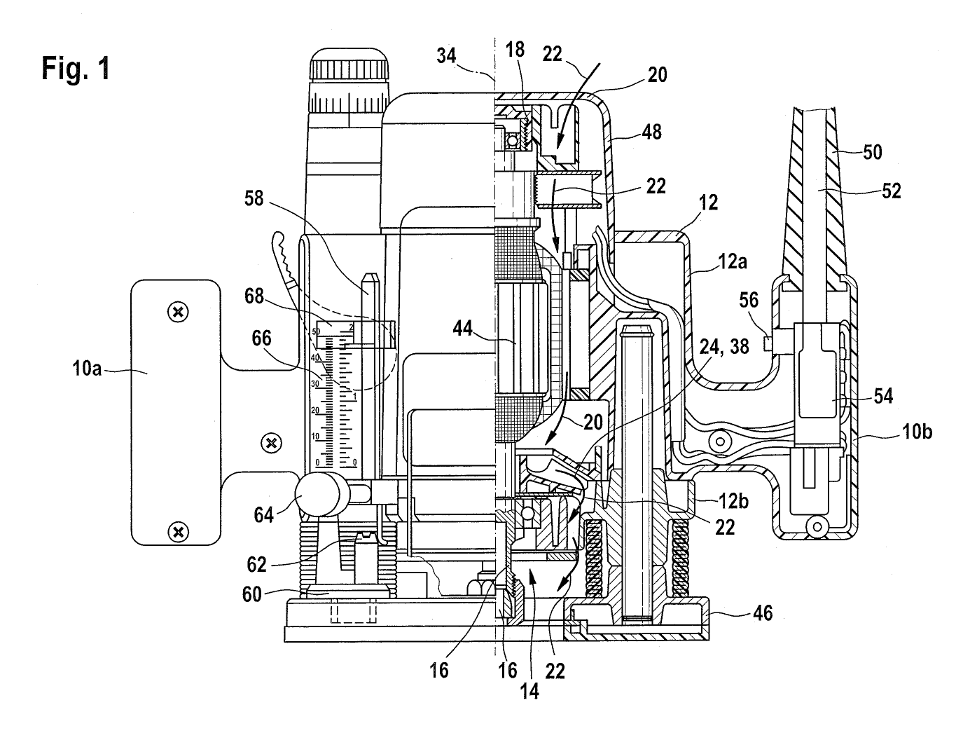

FIG. 1 shows a generic router capable of being operated by an operator, with a motor housing 12 and an electric drive motor 44 located in motor housing 12. Motor housing 12 is designed as two pieces and is composed of an upper piece 12a and a lower piece 12b. Upper piece 12a is preferably made of plastic, and lower piece 12b is preferably made of aluminium. Motor housing 12 is supported on a device base 46 such that it is height-adjustable. A rotary plate 60 with preferably three adjustable screws 62 is installed on device base 46, as a stop for a rod 58, for adjusting the height of motor housing 12.

Rod 58 is fixed on lower piece 12b of motor housing 12 using a fixing screw 64. To more easily adjust the desired height, a scale 66 is provided on housing upper piece 12a, and a displaceable sliding element 68 made of Plexiglas with a marking line is mounted on rod 58. Motor housing 12 includes at least one handle 10a, 10b, and a removable cover 48. Further embodiments of motor housing 12, e.g., without a cover, are also feasible. In the present exemplary embodiment, the router includes two handles 10a and 10b, which are diametrically opposed to each other. Further alternatives are also feasible, however.

Drive motor 44 is operatively connected with a tool fitting 16, which extends out of an underside of motor housing 12. A milling tool may be secured or clamped in tool fitting 16. Drive motor 44 is connected with a connecting line 52, which extends through a protective grommet 50 and out of motor housing 12, and which may represent the connection to a not-shown voltage source. In the present exemplary embodiment, a switch 54 for connecting drive motor 44 to the voltage source, i.e., an on/off switch for drive motor 44, is connected between drive motor 44 and the point at which connecting line 52 exits motor housing 12.

One of the handles 10b is advantageously hollow in design and includes the on/off switch with a pushbutton 56 for drive motor 44, pushbutton 56 being operatively connected with switch 54. Pushbutton 56 is located on the exterior of handle 10b, and switch 54 is located inside handle 10b. When pushbutton 56 is depressed, switch 54 and connecting line 52 connected to the voltage source establish the electrical connection between drive motor 44 and the voltage source in the typical manner.

The router includes a cooling device for cooling drive motor 44, which is located in motor housing 12. Air is typically used for the cooling. To this end, an intake device 18 for drawing cooling air in through intake openings 20 in motor housing 12 is provided in motor housing 12. Intake device 18 is typically a fan wheel 18 that is operatively connected with drive motor 44. The cooling air drawn in through intake openings 20 by fan wheel 18 is directed past a cooling air guide 22 on drive motor 44 to underside 14 of motor housing 12. Fan wheel 18 creates the air motion required for this. The direction of flow of the cooling air directed through cooling air guide 22 is indicated by arrows.

Advantageously, cooling air guide 22 is designed such that the cooling air is capable of being directed around drive motor 44 and axially downwardly to an underside 14 of motor housing 12. Cooling air guide 22, which is now warmed, leads into an exhaust device, which includes means 24 for axially exhausting warmed cooling air via at least one exhaust opening 40, 42 through underside 14 of the router into the surroundings. In the related art, means 24 are several channels 38, which are located in a lower region of motor housing 12, preferably around the circumference.

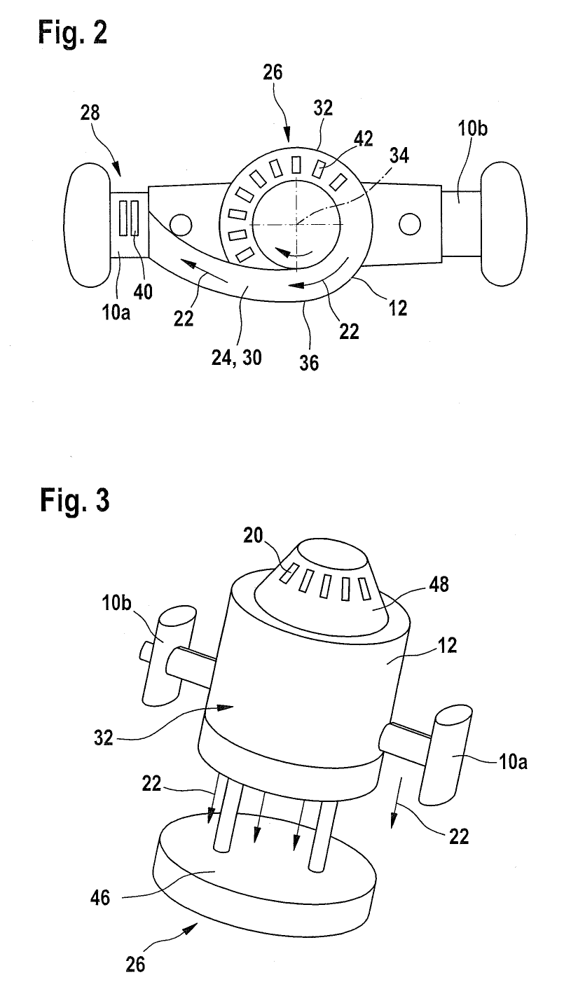

To improve the handling of the router for the operator in particular, it is provided according to the present invention and as shown in FIGS. 2 and 3 that means 24 of the exhaust device are designed such that, when the router is used as intended, the cooling air is only exhausted in at least one region 26, 28 of the router pointing away from the operator.

When the router is used as intended, the operator grips the two diametrically opposed handles 10a and 10b with one hand, so that one side 36 of motor housing 12, the “operator side”, faces the operator, and the other side 32 of motor housing 12 and handles 10a, 10b point away from the operator. Scale 66 and rod 58 with displaceable sliding element 68 are preferably installed on operator side 36 of motor housing 12, so that, when the router is used as intended, the scale faces the operator, and the operator may easily read the numbers on scale 66. Pushbutton 56 of switch 54 is preferably located on motor housing 12 such that, when the router is used as intended, pushbutton 56 may be operated particularly easily by the operator.

Means 24 of the exhaust device is a cooling air channel 30, which leads out of motor housing 12 and into handle 10a, as shown in FIG. 2. As an alternative thereto, but which is not shown here, means 24 of the exhaust device may be a cooling air channel that leads to a side 32 of motor housing 12 of the router facing away from the operator. In the present exemplary embodiment, cooling air channel 30 is designed as a single piece with motor housing 12, although an embodiment as a separate piece would also be feasible.

Cooling air guide 22 leads at least partially into cooling air channel 30. In the present exemplary embodiment, the operator-side, axial cooling air guide 22, i.e., the part of cooling air guide 22 extending on a side 36 of the router facing the operator, is preferably directed into cooling air channel 30, so that a portion of the cooling air reaches handle 10a. The remaining portion of the cooling air is guided axially downwardly toward the underside of motor housing 12 and leads into several axially downwardly guiding channels 38. Cooling air channel 30 is preferably spiral in design.

Cooling air channel 30 leads into at least one exhaust opening 40, 42. The at least one exhaust opening 40, 42 is preferably designed as a slot. In the present exemplary embodiment, cooling air channel 30 leads into several exhaust openings 40 located on an underside 14 of handle 10a. As an alternative, the cooling air channel may also lead into at least one exhaust opening 42, which is located in a region 26 of underside 14 of motor housing 12 facing away from an operator.

Several exhaust openings 42 are preferably located on underside 14 of motor housing 12 in the shape of a half moon.

The embodiment of the cooling device advantageously permits cooling air to be exhausted axially, i.e., it allows the cooling air to be exhausted essentially in the direction of a vertical axis 34 of the router.

It will be understood that each of the elements described above, or two or more together, may also find a useful application in other types of constructions differing from the type described above.

While the invention has been illustrated and described as embodied in a router, it is not intended to be limited to the details shown, since various modifications and structural changes may be made without departing in any way from the spirit of the present invention.

Without further analysis, the foregoing will so fully reveal the gist of the present invention that others can, be applying current knowledge, readily adapt it for various applications without omitting features that, from the standpoint of prior art, fairly constitute essential characteristics of the generic or specific aspects of this invention.

What is claimed as new and desired to be protected by Letters Patent is set forth in the appended claims:

1. A router operatable by an operator, comprising a motor housing including at least one handle; a drive motor; a milling tool connected with said drive motor; a tool fitting provided for said milling tool and extending from an underside of said housing; a cooling device including an intake device for drawing cooling air in through intake openings in said motor housing; a cooling air guide for directing cooling air through said motor housing; and an exhaust device with means for exhausting cooling air out of said motor housing and arranged so that said cooling air guide leads into said exhaust device, said exhaust device being provided with means which are configured such that when the router is used as intended, the cooling air is only exhausted in at least one region of the router pointing away from the operator.

2. A router as defined in claim 1, wherein said means of said exhaust device is configured as a cooling air channel which leads to a side of the router facing away from the operator.

3. A router as defined in claim 1, wherein said means of said exhaust device is configured as a cooling air channel which leads out of said motor housing and into said handle.

4. A router as defined in claim 2, wherein said cooling air guide leads at least partially into said cooling air channel.

5. A router as defined in claim 4, wherein said cooling air guide has a part extending on a side of the router facing the operator and leading into said cooling air channel.

6. A router as defined in claim 1, wherein said cooling air guide has a part extending on a side of the router facing away from the operator and leading into several axially downwardly guiding channels.

7. A router as defined in claim 2, wherein said cooling air channel is configured as a spiral cooling air channel.

8. A router as defined in claim 1; and further comprising means forming at least one exhaust opening, said cooling air channel leading into said at least one exhaust opening.

9. A router as defined in claim 8, wherein said at least one exhaust opening is configured as a slot.

10. A router as defined in claim 8, wherein said at least one exhaust opening is located in an underside of said handle.

11. A router as defined in claim 8, wherein said at least one exhaust opening is located in a region of said underside of said motor housing pointed away from an operator.

12. A router as defined in claim 1; and further comprising means forming several exhaust openings which are located in said underside of said motor housing in a shape of a half moon.
